(19) United States
(12) Patent Application Publication
(10) Pub. No.: US 2004/0202478 A1
(43) Pub. Date: Oct. 14, 2004

(54) Electro-optical module for transmitting and/or receiving optical signals of at least two optical data channels

(76) Inventors: Lutz Melchior, Berlin (DE); Volker Plickert, Brieselang (DE); Martin Weigert, Berlin (DE); Thomas Murphy, Berlin (DE)

Correspondence Address: ESCHWEILER & ASSOCIATES, LLC, NATIONAL CITY BANK BUILDING, 629 EUCLID AVE., SUITE 1210, CLEVELAND, OH, 44114, US

(21) Appl. No.: 10/775,456

(22) Filed: Feb. 10, 2004

(30) Foreign Application Priority Data
Feb. 14, 2003 (DE) 103 07 763.4

(51) Int. Cl. H04B 10/12

(52) U.S. Cl. 398/141

(57) ABSTRACT

The invention relates to an electro-optical module for transmitting and/or receiving optical signals of at least two optical data channels which are guided in an optical waveguide. The module includes at least one transmission component and at least one reception component. According to the invention, the optical waveguide is formed as a single waveguide piece with a bevelled end face which has a wavelength-selective filter or is connected to such a filter. Light from one data channel is reflected at the wavelength-selective filter and coupled out at an angle to the optical axis of the waveguide piece. Light of the other data channel passes through the wavelength-selective filter and enters the bevelled end face. A free beam region is formed between the bevelled end face and the transmission and reception components.

### REFERENCE TO RELATED APPLICATIONS

This application claims the benefit of the priority date of German application DE 103 07 763.4, filed on Feb. 14, 2003, the contents of which are herein incorporated by reference in their entirety.

### FIELD OF THE INVENTION

The invention relates to an electro-optical module for transmitting and/or receiving optical signals of at least two optical data channels.

### BACKGROUND OF THE INVENTION

An electro-optical module is disclosed in EP-A-238 977. Separately encapsulated transmission and reception modules are provided in TO design, and they are mutually adjusted, together with a fibre pigtail, in a common housing and fastened. A free-beam optics is implemented between the fibre pigtail and the transmission and reception modules. A lens serves the purpose of focusing the light beams which are coupled into or out of the fibre pigtail. Moreover, for the purpose of wavelength separation a wavelength-selective filter arranged in the free beam region is provided which separates light emitted by the fibre end from the beam path and feeds it to the reception module.

A disadvantage of this known module is a relatively complex design owing to the use of a plurality of parts (lens, filter) in the free beam region. These parts must be positioned with high accuracy and, in the case of operation in a damp atmosphere, be protected against instances of condensation which can occur.

WO-A-02/088812 discloses an optical arrangement in which waveguide structures and wavelength-selective elements are formed on a substrate, for example, using glass on silicon technology. Transmission and reception modules are arranged on the substrate surface. High costs for the substrate materials are disadvantageous in the case of such arrangements.

WO-A-02/095470 describes an electro-optical module for transmitting and/or receiving optical signals of at least two optical data channels which are guided in an optical waveguide. The optical waveguide forms in the module at least two optical waveguide sections with in each case at least one bevelled end face which is coated in a wavelength-selective fashion, the optical waveguide sections being positioned axially one behind another at the bevelled end faces. For an optical data channel, light is coupled out from the optical waveguide, with light of the optical data channel being reflected at the wavelength-selectively coated end face and in this case being coupled out substantially perpendicular to the optical axis of the waveguide section. The waveguide sections are arranged in a mounting tube centring the sections relative to one another.

Even though this known module requires no additional lenses, and the optical waveguide is guided to the greatest possible extent in the waveguide, there is the disadvantage, nevertheless, that the mounting tubes centring the waveguide sections are relatively expensive and complicated to produce.

### SUMMARY OF THE INVENTION

It is the object of the present invention to make available an optical module for transmitting and/or receiving optical signals which is of simple and compact design, manages with few parts and can be produced cost effectively.

Consequently, the invention is distinguished in that the optical waveguide is formed in the module as a single waveguide piece with a bevelled end face which has a wavelength-selective filter or is connected to such a filter. In this case, firstly, light of one data channel is reflected at the wavelength-selective filter and coupled out or in at an angle to the optical axis of the waveguide piece. Light of the other data channel passes through the wavelength-selective filter and exits from or enters the bevelled end face, light likewise being coupled out or in at an angle to the optical axis of the waveguide piece. Formed between the bevelled end face of the waveguide piece and the transmission component as well as the reception component is a free beam region which is traversed by the light coupled in or out on its way from the transmission component or to the reception component.

The solution according to the invention envisages a design concept in which only an optical waveguide section or a waveguide piece is provided. The light signals of both data channels are coupled into or out of the waveguide piece at the bevelled end face of the waveguide piece. The angle of the bevelled end face is dimensioned in such a way in this case that the light reflected at the end face transirradiates the cladding of the waveguide piece (and any adjacent materials) and is then emitted obliquely. The other signal component passes through the end face of the waveguide piece. This process automatically produces an angular arrangement of transmission component and reception component.

The solution according to the invention is distinguished by a particularly simple and cost effective design, since only one waveguide section is provided and there is therefore no need to use mounting tubes to position individual wave waveguide sections relative to one another. Again, there is no need for any separate beam splitter elements in the free beam region. Lenses which may be present for beam shaping are preferably integrated in the transmission and reception components, and so no separate parts need be arranged and positioned in the free beam region.

It may be pointed out that the arrangement according to the invention comprises both the use of a transmission component and a reception component, and the use of two transmission components or two reception components, light of two wavelengths being coupled into or out of the wave guide piece in the latter case, that is to say the module operates as a multiplexer or demultiplexer. It may also be pointed out that in addition to the actual electro-optical elements such as laser diode and reception diode, the terms of transmission component and reception component also comprise, if appropriate, assigned components such as beam shaping elements, driver modules and monitor diodes. A transmission component or reception component is preferably in each case a micromodule, known per se, for generating or detecting signals.

The angle of the inclined end face of the waveguide piece uniquely determines the relative position of transmission component and reception component, and the direction of the optical beam axes of these components. Thus, both the beam direction of the reflected signal and the beam direction of the light beams entering or exiting the end face are determined uniquely from the law of reflection and the law of refraction.

In a preferred refinement of the invention, the angle of the end face to the optical axis of the waveguide piece is substantially 60°. The optical axis of the component which emits or receives the light reflected at the end face, is then inclined at an angle of approximately 61° to the optical axis of the waveguide piece. The optical axis of the component that emits or receives the light passing through the end face is inclined at an angle of approximately 7° to the optical axis of the waveguide piece. The optical axes of the transmission and reception components are therefore arranged at an angle of other than 90° relative to one another. This also holds for other bevel angles of the end face, and so this feature can be regarded as characteristic of the present invention.

In a preferred refinement of the invention, the waveguide piece comprises a glass ferrule which is transparent to light of the wavelengths used. At its ends, the glass ferrule preferably has an end face bevelled in accordance with the optical waveguide such that there is a plane termination. The reflected light firstly transirradiates the cladding of the optical waveguide and then the glass ferrule, or vice versa. The glass ferrule permits the optical waveguide of the waveguide piece to be held and handled securely.

Since the bevel of the end face of the waveguide piece fixes the position of the transmission and reception components (or of two transmission components or two reception components), given a defined bevel of the end face the transmission component and the reception component can be preassembled at a module housing. The transmission component and the reception component are consequently preferably fastened on a common module housing and positioned thereon at a defined angle to one another.

The transmission component and the reception component are preferably hermetically fixed in advance on the module housing and so after the waveguide piece has also been introduced and fastened in a hermetically tight fashion the housing interior is sealed in a hermetically tight fashion from the outside.

The module housing preferably has defined stops for fastening the transmission component and/or the reception component in a hermetically tight fashion. This permits in a simple way a precise positioning of the components on the module housing, and also simple fastening.

In a preferred refinement, the waveguide piece is preassembled on an insertion part which is inserted into the module housing. The waveguide piece projects in this case with its bevelled end face into the interior of the module housing. The insertion part preferably has a flange via which the insertion part and the waveguide piece can be fastened in a defined arrangement in the module housing. The insertion part is preferably fastened on the module housing by providing a hermetic seal. If, as preferred, there is provision for the two components also to be fastened on the housing in a hermetically tight fashion, the module interior is hermetically sealed off from the outside. There is then advantageously no need for the individual components of the transmission component and reception component also to be of hermetically tight design, as well.

In a preferred refinement, the waveguide piece is positioned in the module housing in such a way that light emitted by the transmission component is focused exactly onto the end face of the waveguide piece. This can be done, for example, because of an active adjustment process. The adjustment is preferably performed with reference to the transmission component, since the reception component generally has a larger receiving surface than the beam aperture from the waveguide piece, and so tolerances are compensated by the large receiving surface. It is therefore preferred that the components of the transmission component focus the light onto the waveguide piece, and that the reception component has a receiving surface of sufficient size, or alternatively a focusing optics.

Instead of an active adjustment, it is also entirely possible in principle to conceive of a passive adjustment, the position of the waveguide piece and the position of the end face being fixed by the position in the insertion part and the position of the latter on the housing.

The transmission and reception components are each preferably arranged on a base plate, in particular a TO base plate (TO header) which can be inserted in each case into a corresponding holding region of the module housing. It is also possible in principle for the transmission and reception components to be arranged in a complete housing, for example a TO housing, which is then inserted into the module housing.

A multiplicity of designs can be selected for the transmission component and the reception component as well as for the base plate or a housing. For example, instead of being arranged on TO headers the transmission and reception components can be arranged on lead frames or flexible wiring carriers. In addition to edge-emitting lasers, it is also possible for vertically emitting lasers (VCSELs), in particular, to be used as transmission components, and these are then coupled directly into the waveguide piece by means of a focusing optics.

The free beam region between the end face of the waveguide piece and the transmission component or the reception component in each case preferably has a lens which serves the purpose of beam focusing. The lens is preferably integrated into the transmission component or reception component such that the free beam region has no separate elements which would have to be positioned.

The waveguide piece projects in a preferably defined fashion from the module housing at its end opposite the bevelled end face. This provides a coupling region for connecting a fibre plug, for example. It is possible in principle for an optical fibre to be connected in this case to the waveguide piece via any desired optical connections.

### BRIEF DESCRIPTION OF THE DRAWINGS

The invention is explained in more detail below with reference to the figures of the drawing and with the aid of an exemplary embodiment. In the drawing:

FIG. 1 shows a first perspective view of an electro-optical module for transmitting and receiving optical signals;

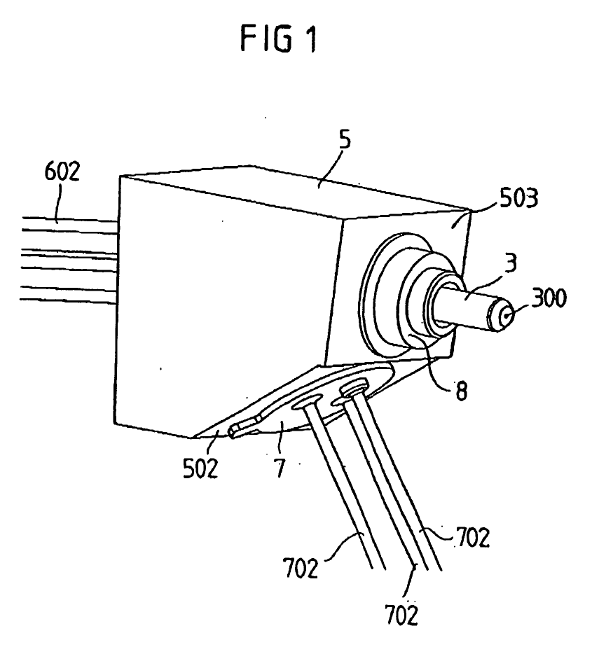

FIG. 2 shows a second perspective view of the module of FIG. 1;

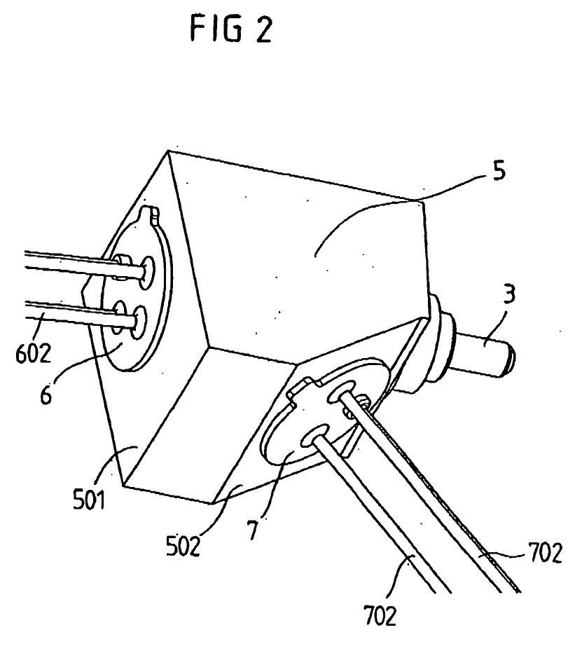

FIG. 3 shows a view from below of the module of FIGS. 1 and 2, and

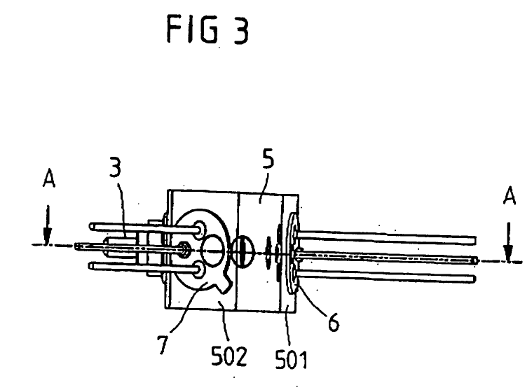

FIG. 4 shows a section through the module of FIGS. 1 to 3 along the line A-A of FIG. 3.

### DETAILED DESCRIPTION OF THE INVENTION

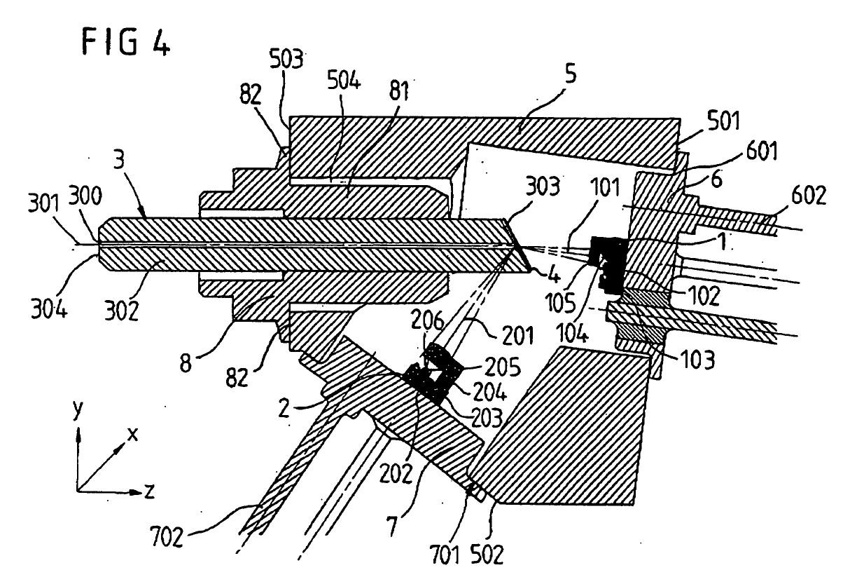

The figures show an electro-optical module for transmitting and receiving optical signals which are transmitted in an optical waveguide (bidirectional transceiver). As illustrated in FIG. 4, the module has a transmission component 1 designed as a micromodule assembly with an optical axis 101, a reception component 2, likewise designed as a micromodule assembly, with an optical axis 201, and a single-mode waveguide 300, arranged in a waveguide piece 3, with an optical axis 301. The transmission component 1, the reception component 2 and the waveguide piece 3 are arranged in a common, unipartite housing 5 and positioned relative to one another thereon.

The transmission component 1 is arranged on a carrier 6 which is of TO design in the exemplary embodiment illustrated, but can also be of other designs in principle. The transmission component or the micromodule assembly 1 comprises a laser chip 102, a monitor diode 103, a mirror surface 104 and a focusing lens 105. The laser chip 102 is designed as an edge-emitting laser chip, the light coupled out of the laser 102 being deflected at the mirror surface 104 by 90° and focused by the lens 105.

In order to fasten the carrier 6 on the housing 5, the said carrier has a circumferential flange surface 601. The latter bears against an assigned stop surface 501 of the module housing 5. Two stop surfaces 501, 601 exhibit an angle of approximately 97° to the optical axis 301 of the waveguide piece 3.

The reception component 2 is likewise arranged on a carrier 7 of TO design. The corresponding micromodule assembly comprises a carrier substrate 203, a reception diode 202 fastened thereon, and a lens 205 fastened thereby on an intermediate carrier 204.

Just like the carrier 5 of the transmission component 1, the carrier 7 of the reception component 2 has a circumferential flange 701 which corresponds to a corresponding stop surface 502 of the housing 5. These stop surfaces 701, 502 are at an angle of approximately 61° to the optical axis 301 of the waveguide piece 3.

The carriers 6, 7 of TO design each have, in a way known per se, electrical bushings 602, 702 with the aid of which the components 1, 2 are fed electric signals. The carriers 6, 7 are hermetically fastened on the housing 5, for example by means of a welding operation.

The above explanation of the transmission and reception components 1, 2 is to be understood merely by way of example. In principle, any desired arrangements of transmission and reception components can be used. For example, the transmission module 1 can have a vertically emitting laser diode. Again, instead of carriers of TO design it is possible to use carriers with other designs.

The optical waveguide 300 is arranged in a glass ferrule 302. Together, they form the waveguide piece 3. The common end faces 303, 304 of optical waveguide 300 and glass ferrule 302 each run in parallel and are ground flat.

The optical waveguide 300 and the glass ferrule 302 are located in an plug-in part 8 which forms a cylindrical part 81 and a flange 82. The cylindrical part 81 serves to receive and hold the waveguide piece 3. The flange 82 corresponds to stop surfaces 503 of the housing 5. This permits a hermetically tight fastening of the plug-in part 8, and thus of the waveguide piece 3 in the housing 5.

The cylindrical part 81 of the plug-in part 8 is inserted in this case into a bore 504 in the housing 5. The diameter of the cylindrical part 81 is smaller than the diameter of the bore 504, and so an active adjustment in the x/y directions can be performed before fastening the plug-in part 8, and thus the waveguide piece 3.

At its end averted from the housing 5, the waveguide piece 3 has a vertical end face 304 which provides an interface to an optical-fibre cable to be fastened on the module. Such an optical fibre cable is fastened on the end of the waveguide section 3 via conventional optical plug-in connections.

The end face 303, formed in the housing interior, of the waveguide piece 3 has a bevel of 60° to the optical axis 301 of the waveguide piece 3 or the optical waveguide 300 in the exemplary embodiment illustrated. A wavelength-selective filter 4 is applied to the end face 303. The filter 4 is applied using a vacuum process, for example. Alternatively, a wavelength-selective filter is applied to a separately produced filter plate which is then fastened on the end face 303, for example bonded to it.

In order to position the end face 303 in the direction of rotation about the optical axis 301, latching marks (not illustrated separately), for example, are provided on the flange 82 of the plug-in part 8 and on the stop surface 503 of the housing 5, the said markings corresponding to one another and providing fastening in a specific angular position. In the exemplary embodiment illustrated, the angular position is such that the bevelled end face 303 runs perpendicular to the plane of the drawing in FIG. 4.

In the exemplary embodiment illustrated, the wavelength-selective filter 4 is transparent to light of a first wavelength which is emitted by the transmission component 1. The wavelength-selective filter 4 is, by contrast, reflecting to light of a second wavelength, which is received by the reception component 2. Consequently, the light which propagates in the waveguide 300 in the direction of the bevelled end face 303 is reflected at the wavelength-selective filter 4. Because of the predetermined geometry, the reflected light firstly transirradiates the cladding region of the optical waveguide 300, and then enters the glass ferrule 302. After transirradiating the glass ferrule 302, it exits the latter and, after traversing a free beam region, is focused onto the reception diode 202 by the lens 205 of the reception component 2.

The reflected light therefore does not exit the end face of the glass fibre 300, but is emitted to the outside through the cladding and the adjoining glass ferrule 302. The optical axis 201 of the reception component runs at an angle of approximately 61° to the axis 301 of the optical waveguide 2.

It may be pointed out that the end face 303 of the waveguide piece 3 preferably has a bevel such that the light reflected at the end face 303 transirradiates the glass ferrule 302 as vertically as possible in order to keep as small as possible a beam deflection owing to a refraction of light at the transition from ferrule to an adjacent free beam region. The alignment at an angle of 60° to the optical axis 301 of the waveguide piece 3 is only one example of a preferred inclined position of the end face.

In one development at least the free beam region between ferrule 302 and reception component 2 is filled with an index-matched potting material, in order to minimize a refraction of light at the ferrule/free beam region transition.

Light emitted by the transmission component 1 is focused exactly onto the end face of the optical waveguide 300 via the lens 105. Since the wavelength-selective filter 4 is transparent to the wavelength of the transmission component 1, the light enters the optical waveguide 300 through the end face 303 and propagates in the optical waveguide 300 in the direction opposite to the light to be detected.

It may be pointed out that the light likewise traverses a free beam region between the transmission component 1 and the end face 303 of the optical waveguide 300. The optical axis 101 of the transmission component 1 runs at an angle of approximately 7° to the optical axis 301 of the optical waveguide 300. The optical axes 101, 201 of transmission component 1 and reception component 2 thereby form an angle of other than 90°. This results in an arrangement typical of the module design described.

The optoelectronic module is assembled by firstly fastening the transmission component 1 and the reception component 2 with the assigned carriers 6, 7 in a hermetically tight fashion on the housing 5. Preassembly is possible, since the bevel of the end face 303 of the optical waveguide 100 defines the relative position of transmission component 1 and reception component 2.

The waveguide piece 3 arranged in the plug-in part 8 is now inserted into the housing 5. An active adjustment in the x/y directions is performed by appropriately displacing the flange 82 on the stop surface 503 of the housing 5. The adjustment is carried out in such a way that the maximum power of the transmission component 1 is coupled into the optical waveguide 2.

The position of the end face 303 in the z-direction is fixed by the length of the waveguide piece 3 in the plug-in part 8, in particular the length of the part projecting from the cylindrical region 81, and is preset. An adjustment with regard to the rotational orientation with respect to the optical axis 301 is performed, as mentioned above, by additional latching markings on the flange 82 and the stop surface 503 of the housing 5, for example.

It is important that the light emitted by the transmission component 1 is focused onto the end face 303 of the optical waveguide 2 during the adjustment. Design tolerances with regard to the reception component 2 are tolerated by virtue of the fact that the reception component 2 has a lens 205 which focuses the beam onto a receiving surface 206 which is preferably larger than the focusing spot of the light to be detected.

The invention is not restricted in its design to the exemplary embodiment described above. For example, given a fundamentally identical design, it is also possible to use two transmission components or two reception components instead of one transmission component and one reception component. Furthermore, the angles used can differ, and the transmission and reception components can be differently designed and be arranged on other types of carriers or in housings. All that is important is that the bevelled end face, provided with a wavelength-selective filter, of an optical waveguide separates signals of two wavelengths, signals of one wavelength passing through the end face, and the signals of the other wavelength being reflected at the end face. The light signals separated in this way propagate via a free beam region to a receiving device, or are emitted by a transmitting device onto the bevelled end face via a free beam region.

1. An electro-optical module for transmitting or receiving optical signals of at least two optical data channels, comprising:
an optical waveguide formed in the module as a single waveguide piece with a bevelled end face that has a wavelength-selective filter associated therewith;
a transmission component emitting light that is coupled into the optical waveguide;
a reception component that receives light coupled out from the optical waveguide,
wherein light of one data channel travels in the optical waveguide and is reflected at the wavelength-selective filter and couples out to the reception component at an angle to an optical axis of the waveguide piece,
wherein light of the other data channel from the transmission component passes through the wavelength-selective filter and enters the bevelled end face, and
wherein a free beam region is formed between the bevelled end face and the transmission component and the reception component, respectively.

2. The module of claim 1, wherein the end face of the optical waveguide is coated with a wavelength-selective filter, or a separate carrier with a wavelength-selective filter is arranged on the end face.

3. The module of claim 1, wherein the angle of the optical waveguide end face to the optical axis of the waveguide piece is substantially 60°.

4. The module of claim 1, wherein the optical axes of the transmission and reception components run at an angle of other than 90° relative to one another.

5. The module of claim 1, wherein the waveguide piece comprises a glass ferrule in which the optical waveguide is located and which is transparent to light of the wavelengths used.

6. The module of claim 1, wherein the transmission component and the reception component are fastened on a common module housing and are positioned thereon at a defined angle to one another.

7. The module of claim 6, wherein the transmission component and the reception component are hermetically fixed in advance on the module housing.

8. The module of claim 6, wherein the module housing comprises defined stops for fastening the transmission component and the reception component thereto in a hermetically tight fashion.

9. The module of claim 6, wherein the waveguide piece is preassembled on an insertion part that is configured for insertion into the module housing.

10. The module of claim 9, wherein the insertion part and the waveguide piece are arranged in a hermetically tight fashion in the module housing.

11. The module of claim 9, wherein the insertion part comprises a flange via which the insertion part and the waveguide piece are fastened in a defined arrangement in the module housing.

12. The module of claim 11, wherein the waveguide piece is positioned in the module housing in such a way that light emitted by the transmission component is focused onto the end face of the waveguide piece.

13. The module of claim 1, wherein the transmission or reception component is respectively arranged on a TO base plate that is inserted into corresponding holding regions of the module housing.

14. The module of claim 1, further comprising a lens provided in the free beam region between the end face of the waveguide piece and the transmission component or the reception component, respectively.

15. The module of claim 14, wherein the lens is integrated into the transmission component or the reception component.

16. The module of claim 6, wherein the waveguide piece projects in a defined fashion from the module housing at its end opposite the bevelled end face.

17. The module of claim 1, wherein the optical waveguide comprises a single-mode waveguide.
